(19) United States
(12) Patent Application Publication
(10) Pub. No.: US 2016/0263598 A1
(43) Pub. Date: Sep. 15, 2016

(54) FLUID APPLICATOR

(71) Applicant: Lawewnce KAPLAN, Upper Dicker Sussex (GB)

(72) Inventor: Lawrence Kaplan, Upper Dicker, East Sussex (GB)

(21) Appl. No.: 15/028,302

(22) PCT Filed: Oct. 14, 2014
(86) PCT No.: PCT/GB2014/053085

§ 371 Date: Apr. 8, 2016

(30) Foreign Application Priority Data
Oct. 14, 2013 (GB) 1318192.0

(51) Int. Cl. B05B 9/047; B05B 12/00

(52) U.S. Cl. CPC B05B 9/047; B05B 12/00

(57) ABSTRACT

A fluid applicator (1, 20) applies a fluid, such as flux, to the external surfaces of a pipe (22). The fluid applicator (20) has a fluid reservoir (24) containing the fluid to be applied to a pipe (22), and a fluid carrier (94) to receive fluid from the fluid reservoir (24). The fluid (carrier 94) is supported by a cylindrical sleeve (90) formed around the fluid reservoir (24). The cylindrical sleeve (90) is moveable between a position in which fluid is received by the fluid carrier (94), and a position in which the fluid carrier (94) applies fluid to a pipe end.

### FIELD OF THE DISCLOSURE

The present disclosure relates to a fluid applicator, in particular to a fluid applicator for applying fluid to an external surface of an end of a tube or pipe. The disclosure is particularly, but not exclusively, applicable to a fluid applicator for applying soldering flux to an external longitudinal surface of an end of a pipe.

### BACKGROUND TO THE DISCLOSURE

Many situations arise in which it is desirable to coat a tube or pipe with a fluid agent. For example, in pipe joining processes such as welding, brazing and soldering, flux is often applied to the intended contact surfaces of the pipes after cleaning of the surfaces to prevent oxidization of the metal, and to provide a key allowing solder to flow easily. Other situations arise in which it is necessary to apply other fluid agents, such as paint, glaze, adhesive or dye, to the surface of a tube.

When applying fluid agents to pipe surfaces, it is often important that the correct amount of agent be applied, as well as being important that the fluid agent is applied to a sufficient extent of the pipe surface. In many cases, it is important that contamination of the fluid agent to be applied to the pipe is avoided.

At present, flux is commonly applied to pipes by dipping a brush into a pot of flux and painting the flux on the pipe. This method does not ensure that the correct amount of flux is applied to a sufficient extent. This work is often carried out in dusty or dirty environments and the flux, brush or copper pipe can often become contaminated with dust or dirt. Moreover, flux is very corrosive, and excess flux can fall onto other metal parts and corrode the other metal parts, or be hazardous to the skin.

A tool for applying flux to a pipe is disclosed in U.S. Pat. No. 5,908,253. A removable flux cartridge is provided, having an orifice for discharge of flux from the cartridge onto a flux applicator, for applying the flux to a pipe. In use, the operator uses a lever to dispense flux from the cartridge to the flux applicator, and the operator then applies the dispensed flux from the flux applicator to the surface of the pipe. However, the tool disclosed in U.S. Pat. No. 5,908,253 is not easy to use, and requires the operator to use both hands to hold the pipe and tool, and to operate the lever to dispense the flux.

The invention seeks to ameliorate or eliminate the drawbacks in the prior art and to provide a novel fluid applicator.

### SUMMARY OF THE DISCLOSURE

According to one aspect of the invention, there is provided a fluid applicator, comprising a fluid reservoir having a dispensing aperture, a pipe locator for locating a pipe end at a coating position in use of the fluid applicator, a cylindrical sleeve around the fluid reservoir, and a fluid carrier carried by the cylindrical sleeve, wherein the cylindrical sleeve is moveable between a first position, in which the dispensing aperture is in fluid communication with the fluid carrier and a second position in which the fluid carrier is adjacent a pipe end located at the coating position.

Optionally the fluid applicator includes a fluid distributor disposed within the cylindrical sleeve, the fluid distributor being arranged to provide a fluid distribution path between the dispensing aperture of the fluid reservoir and the fluid carrier.

Optionally the fluid distributor has an inner bore and an external surface, the fluid reservoir and fluid distributor being arranged such that the dispensing aperture of the fluid reservoir is located within the inner bore of the fluid distributor, wherein the fluid distribution path comprises a plurality of dispensing channels extending radially outwardly from the inner bore to the external surface of the fluid distributor.

Optionally the fluid applicator includes a pipe disposed between the fluid reservoir and the dispensing aperture, the pipe being disposed within, and able to move relative to, the inner bore of the distributor in a sealed manner.

Optionally the fluid applicator includes a spring, wherein the fluid distributor and the fluid reservoir are arranged longitudinally within the cylindrical sleeve separated by the spring.

Optionally the pipe locator is fixedly attached to the fluid distributor within the cylindrical sleeve.

Optionally the fluid applicator includes an O-ring seal disposed between the fluid distributor and the cylindrical sleeve.

Optionally the fluid applicator includes pressurizing means for causing fluid in the fluid reservoir to be dispensed through the fluid aperture in response to the relative motion of the fluid reservoir and the distributor caused by the movement of the sleeve.

Optionally the fluid reservoir includes a plate, moveable within the fluid reservoir, and a biasing mechanism, responsive to the fluid pressure within the fluid reservoir, for moving the plate within the fluid reservoir to maintain fluid pressure in the fluid reservoir.

Optionally the fluid applicator includes a one way valve, arranged to cooperate with the dispensing aperture to allow fluid to be dispensed from the dispensing aperture during movement of the sleeve from the first position of the sleeve to the second position of the sleeve, and to prevent fluid passing through the dispensing aperture during movement of the sleeve from the second position of the sleeve to the first position of the sleeve.

Optionally the fluid applicator includes an end cap at the trailing end of the cylindrical sleeve, and an end cap spring disposed between the end cap and the fluid reservoir.

Optionally the fluid applicator includes an annular ring having a wiping portion disposed on a leading end of the cylindrical sleeve adjacent the coating position, the wiping portion being arranged to wipe off excess fluid applied by the fluid carrier.

Optionally the fluid applicator includes an annular ring having a locating portion disposed on a leading end of the cylindrical sleeve adjacent the coating position, the locating portion being shaped to co-operate with the pipe locator to align a pipe with the fluid applicator during use of the fluid applicator.

Optionally the fluid applicator includes an annular ring having a sealing portion disposed on a leading end of the cylindrical sleeve adjacent the coating position, the sealing portion being shaped to retain fluid in the fluid applicator.

Optionally the cylindrical sleeve supports the fluid carrier on an inner wall of the cylindrical sleeve.

Optionally the fluid carrier comprises an annular support mounted within the cylindrical sleeve, and a plurality of fluid carrier pads supported by the annular support.

Optionally pressure means is provided to pressurize fluid in the fluid reservoir to pass fluid through said dispensing aperture onto the fluid carrier.

Optionally the pressure means may be a piston and cylinder device.

Optionally the piston may be driven by rotation of a screw thread shaft passing through a screw threaded aperture in the piston.

Optionally one end of the fluid reservoir may include a projection to engage the inside of a pipe to be coated with fluid.

Optionally the projection may be conical.

Optionally the action of sliding the sleeve from the first position to the second position and/or vice versa operates said pressure means to dispense fluid through said apertures onto the fluid carrier, whereby the fluid carrier is always primed with fluid before the sleeve is moved from the first position to the second position.

Optionally the fluid is soldering flux.

According to another aspect of the invention there is provided a flux applicator comprising:

a) a housing containing flux with a dispensing aperture at one cylindrical end,

b) a cylindrical sleeve around the housing to slide from a first position normally sealing the apertures to second position extending from the housing, said sleeve supporting a pad on an inner wall to support flux from the housing dispensing aperture,

in use a pipe end to be coated with flux can be placed adjacent said one end of the housing and the sleeve moved from the first position where flux is applied to the pad to a second position where the sleeve embraces the pipe end and the pad applies flux to the pipe end.

Optionally, pressure means is provided to pressurize flux in the housing to pass flux through said apertures onto the sleeve pad. In some examples, the pressure means may be a piston and cylinder device. In some embodiments, the piston may be driven by rotation of a screw thread shaft passing through a screw threaded aperture in the piston.

Optionally, the housing end may include a projection to engage the inside of a pipe to be coated with flux. In some embodiments, the projection may be conical.

Optionally, the action of sliding the sleeve from the first position to the second position and/or vice versa operates said pressure means to dispense flux through said apertures onto the sleeve pad, whereby the pad is always primed with flux before the sleeve is moved from the first position to the second position over the pipe.

Embodiments of the invention will now be described, by way of example only, with reference to the accompanying drawings.

### BRIEF DESCRIPTION OF DRAWINGS

FIG. 1 is a perspective view of a flux applicator in accordance with a first embodiment.

FIG. 2 is a longitudinal cross sectional view of the flux applicator as shown in FIG. 1, with a sleeve in a first position.

FIG. 3 is a longitudinal cross sectional view of the flux applicator as shown in FIG. 1, with the sleeve in a second position.

FIG. 4 is a longitudinal cross sectional view of a fluid applicator in accordance with a second embodiment in an initial position of the fluid applicator.

FIG. 5 is an exploded perspective view of a fluid distributor.

FIG. 6 is a longitudinal cross sectional view showing the fluid applicator of FIG. 4 in a fluid dispensing position of the fluid applicator.

FIG. 7 is a longitudinal cross sectional view showing the fluid applicator of FIG. 4 in a fluid application position of the fluid applicator.

FIG. 8 is a longitudinal cross sectional view showing the fluid applicator of FIG. 4 in a fluid priming position of the fluid applicator.

### DETAILED DESCRIPTION OF PREFERRED EMBODIMENTS

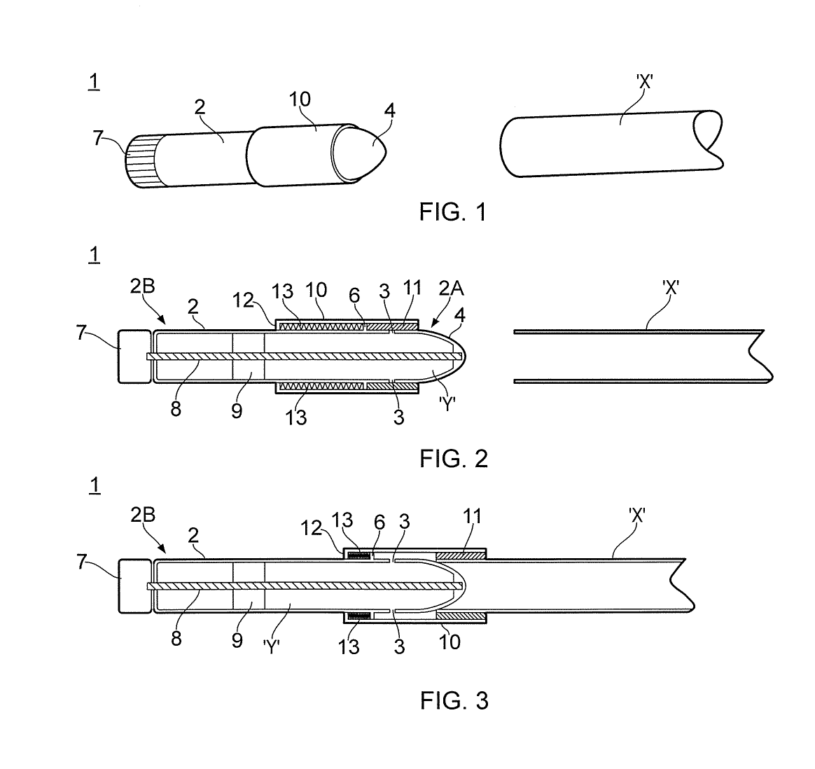

FIGS. 1-3 show a first embodiment of a fluid applicator 1 for applying fluid to the external surface of the end of a pipe X. In this example, the fluid is soldering flux, and so the description refers to a flux applicator 1. However, the applicator 1 may be used to apply other fluids, and more particularly liquids, as will be understood by a skilled person.

The flux applicator 1 is provided with an elongate cylindrical housing 2 having a first cylindrical end 2A and a second end 2B at the opposite end of the elongate cylindrical housing 2. The cylindrical housing 2 contains flux Y. Housing 2 has at least one dispensing aperture in the form of one or more slots 3 at the first cylindrical end 2A of the housing 2. The slot or at least one of the slots 3 may extend in a circumferential direction around the housing 2.

The cylindrical end 2A has a conical projection 4. The conical projection 4 has a base with a diameter substantially equal to the internal diameter of pipe X.

A rib 6 is provided on the external surface of the housing 2. The rib 6 may extend in a circumferential direction around the housing 2.

A knurled knob 7 is provided at the second end 2B of housing 2. The knurled knob 7 is supported on a threaded shaft 8 that extends through housing 2 and is axially aligned with the axis of housing 2. In some embodiments, the knurled knob 7 may be provided with a ratchet (not shown) so it only rotates one way.

In use, rotation of knurled knob 7 pressurizes the flux Y in housing 2, so forcing flux Y out of the slots 3. In some embodiments, a slipping clutch (not shown) may be provided to restrict the maximum pressure on the flux Y that can be applied by the rotation of the knurled knob.

The flux applicator 1 is provided with a collar 9 forming a piston sealed against the internal surface of housing 2, with the internal surface of housing 2 forming a cylinder co-operating with a piston formed by the collar 9.

A cylindrical sleeve 10 is provided around the housing 2. The cylindrical sleeve 10 is arranged so as to be able to slide between a first position normally sealing the apertures, as shown in FIG. 2, and a second position extending from the housing 2, as shown in FIG. 3.

Sleeve 10 supports a carrier 11 on an inner surface to receive and support flux dispensed from the slots 3, and to seal the slots 3 when the sleeve 10 is in the first position. In the embodiment shown in FIGS. 1-3, the carrier 11 is an annular pad.

Sleeve 10 has an inwardly directed annular flange 12 which is biased away from rib 6 by springs 13, so biasing the sleeve 10 into the first position in which the sleeve 10 covers and seals slots 3. As a result, flux Y in housing 2 does not dry out when the flux applicator 1 is not in use.

During use of the flux applicator 1, the knob 7 is first rotated to pressurize the flux Y and apply flux Y to carrier 11.

Next, an end of the pipe X that is to be coated with flux Y is placed adjacent one end of the housing 2 over projection 4.

The sleeve 10 is moved from the first position, as shown in FIG. 2, in which flux Y from the housing 2 may be applied to the pad 11 through slots 3, to a second position, as shown in FIG. 3, in which the sleeve 10 embraces the end of the pipe X and the carrier 11 applies flux to the external surface of the end of the pipe X.

It is envisaged that the flux applicator 1 could be sold pre-filled with flux Y as a disposable item. Alternatively the flux Y could be in a replaceable cartridge (similar to a sealant cartridge) which could be placed in the housing 2 and pressurized, as described above.

It is also envisaged that in some embodiments the action of sliding the sleeve 10 from the first position to the second position and/or vice versa ensures that flux Y is automatically dispensed through slots 3 onto carrier 11. In this way, the carrier 11 is always primed with flux Y before the sleeve 10 is moved from the first position to the second position over the pipe X.

Various mechanisms could be provided to do this, as will be apparent to a skilled person. In one embodiment, the sleeve 10 may extend back over the knurled knob 7, and “cams” on the sleeve could engage with “cam followers” on the knob 7 (or vice versa) to rotate the knob 7 each time the sleeve 10 slides from the first position to the second position.

The described mechanism would allow new flux Y to be forced through slots 3 as the sleeve 10 coats the pipe X with flux, and the carrier 11 would then be re-coated with new flux as the sleeve returned to the second position with the carrier 11 covering the slots 3.

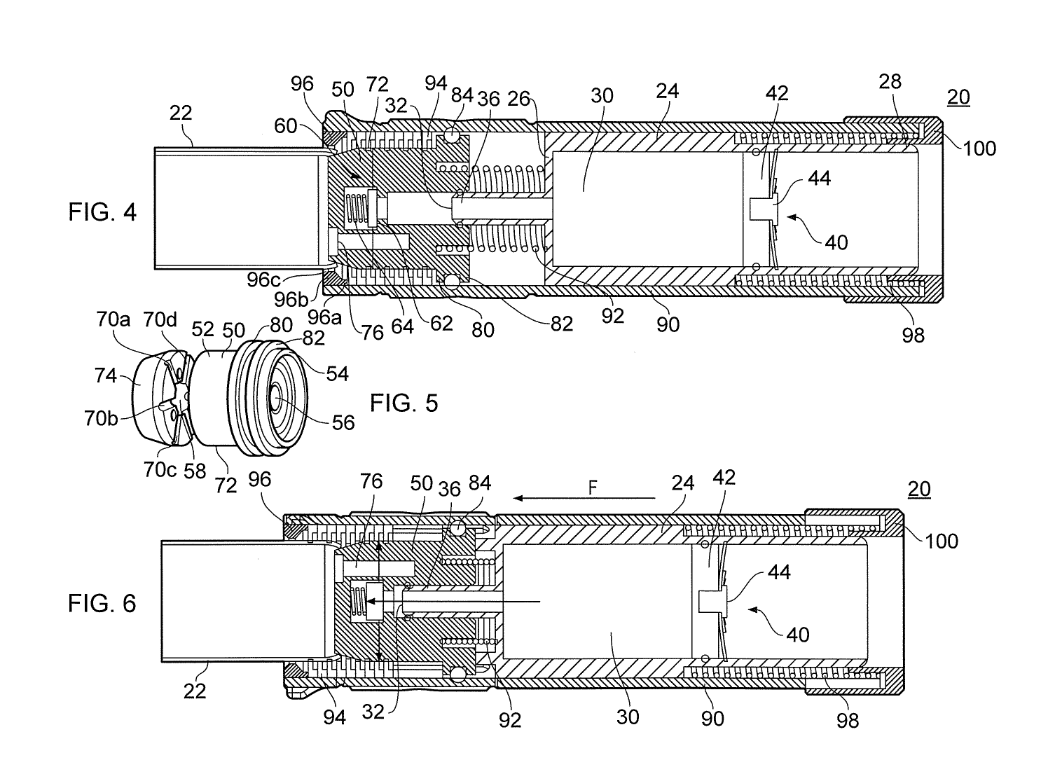

A fluid applicator 20 in accordance with a second embodiment will now be described with reference to FIGS. 4-8.

FIG. 4 is a longitudinal cross sectional view of a second embodiment of a fluid applicator 20, for applying fluid to the external longitudinal surface of a pipe 22.

The fluid applicator 20 has a fluid cartridge 24. The fluid cartridge 24 in the illustrated embodiment is generally cylindrical, and has a cartridge front end 26 and a cartridge rear end 28.

The fluid cartridge 24 has a fluid reservoir 30 for the fluid to be applied by the fluid applicator 20. The fluid reservoir 30 has a dispensing aperture 32 for dispensing fluid from the fluid reservoir 30 during the use of the fluid applicator 20. In the embodiment shown in FIG. 4, the dispensing aperture 32 is located at a cartridge front end 26 of the fluid cartridge 24.

In the embodiment shown in FIGS. 4-8, the fluid cartridge 24 is provided with a pipe 36 disposed between the fluid reservoir 30 and the dispensing aperture 32, for conveying fluid from the fluid reservoir 30 to the dispensing aperture 32.

In some embodiments, the fluid reservoir 30 of the fluid cartridge 24 is provided with a priming mechanism 40 for ensuring priming of the fluid applicator 20 with fluid, ready for use of the fluid applicator 20.

In the illustrated embodiment, the priming mechanism 40 is provided by a plate 42, disposed within the fluid reservoir 30, and biasing mechanism 44. The plate 42 is biased by the biasing mechanism 44 in a direction from the cartridge rear end 28 towards the cartridge front end 26 of the fluid cartridge 24. As a result, the plate 42 is able to move within the fluid reservoir 30 in response to a reduction in the volume of the fluid reservoir 30 as the fluid is dispensed from the fluid aperture 32, so as to maintain fluid pressure in the fluid reservoir 30.

In some embodiments, it is envisaged that the fluid cartridge 24 will be integrated in the fluid applicator 20. In other embodiments, it is envisaged that the fluid cartridge 24 will be removable from, and replaceable within, the fluid applicator 20.

The fluid applicator 20 has a fluid distributor 50 arranged to receive fluid from the dispensing aperture 32 of the fluid cartridge 24. The fluid distributor is arranged to provide a fluid distribution path between the dispensing aperture of the fluid reservoir and a fluid carrier.

Features of the fluid distributor 50 will be described in more detail with reference to FIGS. 4 and 5. FIG. 5 is an exploded perspective drawing of the fluid distributor 50 in accordance with one embodiment of the invention.

The fluid distributor 50 is generally cylindrical, and has a distributor front end 52, and a distributor rear end 54.

The fluid distributor 50 is provided with an inner bore 56. In the embodiment shown in FIGS. 4-8, the inner bore 56 runs centrally in a longitudinal direction within the fluid distributor 50 from the distributor rear end 52 to a fluid distribution point.

The distributor rear end 52 is oriented with respect to the cartridge front end 26 so that the dispensing aperture 32 is arranged to dispense fluid from the fluid reservoir 30 within the inner bore 56 of the fluid distributor 50.

In some embodiments, the end of pipe 36 fits within and seals inner bore 56 of fluid distributor 50. Relative movement between the fluid reservoir 30 and the fluid distributor 50 during operation of the fluid applicator 20 results in the relative movement of the fluid aperture 32 at the end of pipe 36 along the inner bore 56.

In embodiments of the invention, the fluid distributor 50 is provided with a one way valve 60 comprising a valve body 62 disposed within the fluid distributor 50 at the end of the inner bore 56 of the fluid distributor 50, and a spring 64 disposed within the fluid distributor 50 to bias the valve body 62 to seal the end of the inner bore 56 of the fluid distributor 50.

Thus, the one-way valve 60 is arranged to allow fluid to be dispensed into a fluid distribution path of the fluid distributor 50 from the dispensing aperture 32, but to prevent return of fluid to the fluid reservoir 30 from the fluid distributor 50, as will be understood by a skilled person from a consideration of the following description.

In some embodiments, the one way valve 60 may be provided as part of the fluid cartridge 24, for example at the fluid aperture 32, instead of as part of the fluid distributor 50 as described herein.

The fluid distributor 50 is provided with a plurality of dispensing channels 70a-70d extending generally radially outwardly from the inner bore 56 to the external surface 72 of the fluid distributor 50. The plurality of dispensing channels 70a-70d together with the inner bore 56 provide the fluid distribution path to distribute the fluid dispensed by the fluid dispensing aperture 32 outwardly through the fluid distributor 50 to the external surface 72 of the fluid distributor 50.

At the front end 52 of the fluid distributor 50, a pipe locator 74 is provided to engage and align the end of a partially inserted prepared pipe 22 (not shown in FIG. 5). The pipe locator 74 may be conically shaped in order to locate a pipe end to be coated with fluid at a coating position.

In some embodiments, the pipe locator 74 may be formed integrally with the fluid distributor 50. In other embodiments, the pipe locator 74 may be formed separately and attached to the fluid distributor 50, for example using one or more screws 76 or other fastenings.

On the outer circumference of the fluid distributor 50 are formed first and second raised O-ring locators 80, 82. An O-ring seal 84 is disposed between the O-ring locators 80, 82. As will be apparent to a skilled person, one or more O-rings may be used in other embodiments.

The fluid applicator 20 is provided with a generally cylindrical outer sleeve 90 having a leading edge adjacent pipe locator 74 and a rear end adjacent fluid cartridge 24. The fluid cartridge 24 and the fluid distributor 50 are disposed within the outer sleeve 90 in a generally longitudinally adjacent arrangement, with the cartridge front end 26 being adjacent the distributor rear end 52. A spring 92 is disposed between the fluid cartridge 24 and the fluid distributor 50.

A fluid carrier 94 is carried by the cylindrical sleeve 90 such that the fluid carrier 94 moves with the sleeve 90 during longitudinal movement of the sleeve 90. The fluid carrier 94 can be formed by one or more fluid application pads in accordance with different embodiments.

In some embodiments, the cylindrical sleeve 90 supports the fluid carrier 94 on an inner wall of the cylindrical sleeve 90.

In some embodiments, the fluid carrier 94 comprises an annular support and a plurality of fluid carrier pads is mounted on the annular support. The annular support may be mounted within and carried by the cylindrical sleeve 90 in a number of ways, as selected by a skilled person.

In some embodiments, the cylindrical sleeve 90 may be provided with a portion having a larger internal diameter at the front end of the cylindrical sleeve to accommodate the annular support within the cylindrical sleeve 90. A face of the cylindrical sleeve 90, between a forward larger internal diameter portion and a rearward smaller diameter portion, may then be adjacent the side of the annular support of the fluid carrier 94 so as to provide a forwards force to carry the annular support along with the cylindrical sleeve 90 during forward movement of the cylindrical sleeve 90 during operation of the fluid applicator 20.

In the exemplary embodiment shown in FIG. 4, the dispensing aperture 32 is in fluid communication with the fluid carrier 94 via a fluid distribution path. The fluid distribution path comprises the inner bore 56 and the plurality of dispensing channels 70a-70d. The fluid distributor 50 distributes the fluid dispensed from the dispensing aperture 32 via the dispensing channels 70 to the external surface 72 of the fluid distributor 50 adjacent the fluid carrier 94, to apply the fluid to the fluid carrier 94.

As will be explained in more detail in the following description, an annular ring 96 may be provided at the leading end of the sleeve 90 of the fluid applicator 20. In the embodiment shown in FIGS. 4-8, the annular ring 96 performs a sealing function, a wiping function and a pipe locating function. However, in some embodiments one or more of these functions may be omitted, or may be provided separately.

In some embodiments annular ring 96 includes a seal portion 96a that operates to seal the fluid applicator 20, and to prevent leakage of fluid from within the fluid applicator 20. All fluid carried by the fluid carrier 94 is therefore retained within the fluid applicator 20.

In some embodiments annular ring 96 has a wiping portion 96b spaced from the pipe in the coating position. The wiping portion 96b operates to provide a wiping action, so as to leave a coating of fluid and to wipe off any excess fluid that has been applied to the pipe 22 by the fluid carrier 94. The depth of fluid applied can therefore be controlled by varying the spacing of the wiping portion 96b from the expected surface position of a pipe at the coating position.

In some embodiments annular ring 96 has a locating portion 96c, that co-operates with the pipe locator 74 to guide pipe 22 and to ensure alignment of the pipe 22 with the fluid applicator 20. In some embodiments, the locating portion 96c may be provided by a chamfered leading edge or other profile facilitating the alignment of the pipe with the fluid applicator 20.

The annular ring 96 may co-operate with the conically shaped pipe locator 74 to ensure that no fluid enters the internal surface of the pipe 22 during application of the fluid to the external surface of the pipe 22.

In embodiments in which a plurality of fluid carrier pads are mounted on an annular support accommodated within a front portion of the cylindrical sleeve 90 having a larger internal diameter, the annular ring 96 may provide a retaining surface for retaining the annular support within the front portion of the cylindrical sleeve 90.

The sleeve 90 is provided with a spring 98 disposed between the sleeve 90 and the fluid cartridge 24 to allow relative movement between the sleeve 90 and the fluid cartridge 24, as will be apparent from the following description. The spring 98 is retained within the sleeve 90 by way of an annular end cap 100 provided at the trailing end of sleeve 90.

In some embodiments the end cap 100 may be provided with vent holes (not shown) to enable the venting of air from the fluid applicator 20 during the forward movement of the sleeve 90 of the fluid applicator 20 during use.

The operation of the fluid applicator 20 will now be described with reference to FIG. 4 and FIGS. 6-8. FIG. 4 and FIGS. 6-8 illustrate the relative positions of the components of the fluid applicator 20 as described above, during operation of the fluid applicator 20.

As described above, FIG. 4 shows the fluid applicator 20 in an initial position. In the initial position shown in FIG. 4, the end of pipe 22 is engaged with the pipe locator 74 to align the pipe 22 with the fluid applicator 20 in a coating position of the pipe 22 relative to the pipe locator 74. In the exemplary embodiment, the annular seal 96 has a chamfered leading edge that facilitates the alignment of the pipe 22 with the fluid applicator 20.

As will become clear from a consideration of the following description, in some embodiments of the flux applicator 20, the fluid carrier 94 is primed with fluid to be applied to the end of the pipe 22 as a result of the previous operation of the fluid applicator 20.

FIG. 6 is a cross section view showing the fluid applicator 20 in a fluid dispensing position.

In the fluid dispensing position shown in FIG. 6, the outer sleeve 90 has been pushed in a forward direction F relative to the initial position shown in FIG. 4, and starts to travel over the end of the pipe 22 engaged by the pipe locator 74 at the coating position.

The front end of ring 96 engages over the pipe 22 and starts to travel over the external surface of the pipe 22, exposing the external surface of the pipe 22 to the fluid carrier 94.

The spring 98 is a relatively strong spring, and the movement of sleeve 90 in the forward direction F causes the fluid cartridge 24 also to move in the forward direction. The resulting relative motion between the fluid cartridge 24 and the fluid distributor 50 results in the compression of spring 92 until the spring 92 is fully compressed and the fluid cartridge 24 and the fluid distributor 50 are adjacent.

The dispensing aperture 32 remains located within inner bore 56 the fluid distributor 50 and the relative movement of the fluid cartridge 30 and the fluid distributor 50 results in the dispensing of fluid through the dispensing aperture 32 into the fluid pathway. One way valve 60 is open.

The dispensed fluid then travels outwardly via the dispensing channels 70a-70d of the fluid pathway to the external surface 72 of fluid distributor 50 to apply fluid to fluid carrier 94 adjacent the external surface 72, as shown in FIG. 6. The seal 96 and the O-ring seal 82 prevent leakage of the dispensed fluid out of the fluid applicator 24.

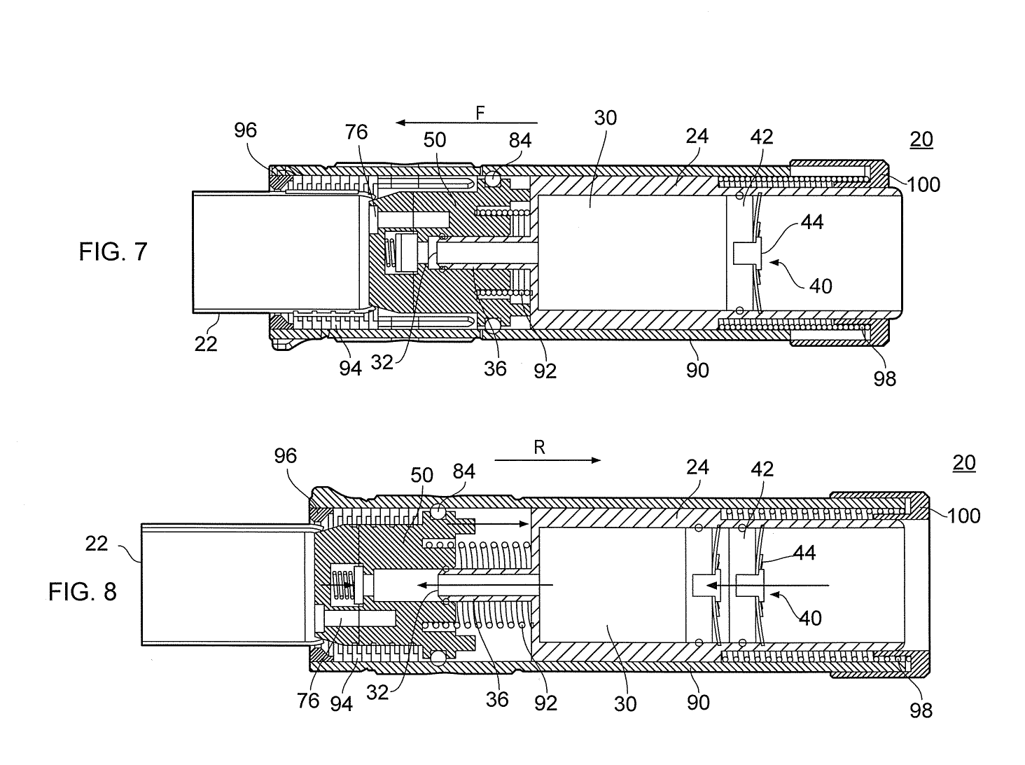

FIG. 7 is a cross sectional view showing the fluid applicator 20 in a fluid application position.

In the fluid application position shown in FIG. 7, the sleeve 90 has been moved an additional distance in the forward direction F relative to the fluid dispensing position shown in FIG. 6. The spring 92 is fully compressed in the fluid dispensing position shown in FIG. 6, and so the further relative movement of the sleeve 90 and the pipe 22 causes the expansion of the spring 98.

The fluid carrier 94 carried on the inner surface of sleeve 90 is therefore moved adjacent to external surface of the pipe 22 to apply the dispensed fluid to the external surface of the pipe 22. The length of the pipe 22 that receives the fluid coating may be selected merely by controlling the length of the pipe over which the fluid carrier travels. The fluid is spread evenly on the end of the pipe owing to the action of the wiping portion 96b of ring 96.

FIG. 8 is a cross sectional view showing the fluid applicator in a fluid priming position of the fluid applicator.

In the fluid priming position shown in FIG. 8, the sleeve 90 has been moved in a reverse direction R, opposite to the forward direction F previously, in order to return the fluid applicator to the initial position as shown in FIG. 4.

The reverse motion of the sleeve 90 initially releases the spring 98 owing to relative motion between the sleeve 90 and the fluid cartridge 24. Thereafter, the fluid cartridge 24 is carried along with sleeve 90 in the reverse direction, leading to relative movement of the fluid cartridge 24 and the fluid distributor 50 in the reverse direction.

The relative movement of the fluid cartridge 24 and the fluid distributor 50 results in the movement of the dispensing aperture 32 with respect to the inner bore 56.

The one way valve 60 is shut, and therefore fluid within the fluid distributor 50 cannot be drawn back through the dispensing aperture 32. As a result, a reduction in fluid pressure arises in the fluid cartridge 50.

As discussed above, the plate 42 is biased by the biasing mechanism 44 in a direction from the cartridge rear end 28 to the cartridge front end 26 of the fluid cartridge 24. As a result, the plate 42 is able to move within the fluid reservoir 30 in response to a reduction in the pressure in the fluid reservoir 30, so as to maintain fluid pressure in the fluid reservoir 30.

The priming mechanism therefore ensures that the fluid cartridge is primed and able to dispense further fluid.

As will be apparent to a skilled person, a novel fluid applicator has been provided for applying a liquid to the external surface of a pipe or other cylindrical object. In some embodiments, the disclosed fluid applicator may be used to apply flux to the outer surfaces of a tube or pipe, for example a copper pipe used in plumbing, prior to soldering of the tube or pipe.

The fluid applicator in accordance with embodiments of the invention may facilitate accurate fluid application. In particular, full fluid coverage of the pipe can be achieved and fluid can be applied to an exact depth. Fluid over-run can be minimized or eliminated and a consistent quantity of delivered fluid can be achieved.

The fluid applicator in accordance with embodiments of the invention enables fluid to be applied while maintaining a healthy environment for the operator. This may be important when the fluid being applied is harmful to health. One example of a liquid harmful to health is flux, since some of the constituents of flux are poisons. A flux applicator in accordance with embodiments of the invention helps to reduce flux contact with skin and also reduces the release of harmful chemicals, for example ammonium chloride, hydrochloric acid, and zinc chloride, during the soldering process.

The fluid applicator in accordance with embodiments of the invention enables contamination of the fluid to be minimized or eliminated by providing a sealed system. The provision of a single-use fluid cartridge in some embodiments enables contamination to be eliminated.

In addition, the fluid applicator in accordance with embodiments of the invention minimizes or at least reduces the amount of fluid used. In particular, the sleeve seal controls the thickness of the fluid coating layer applied to the end of the tube or pipe.

The fluid applicator in accordance with embodiments of the invention enables an improved ease of operation with respect to prior art devices.

In particular, the fluid applicator in accordance with some embodiments allows one handed operation, and enables the fluid applicator to be used in tight spaces and/or to apply fluid to unsighted pipes.

Furthermore, a clean operation can be achieved by fluid applicators in accordance with some embodiments, since the need to wipe off excess fluid is reduced or eliminated.

Fluid applicators in accordance with embodiments of the invention may help to enable the soldering process to be standardized and mechanized. This leads to a rapidly repeatable process resulting in a significantly improved speed of application, in some cases around 20-30 times as quick as a brush.

Fluid applicators in accordance with some embodiments of the invention are self priming, for repeatedly and consistently applying fluid. A multi-step application is provided in which fluid is first distributed or transferred onto a fluid carrier, such as fluid applicator pads, via dispensing apertures in communication with a fluid reservoir, and then the fluid is transferred from the fluid carrier onto the external surface of the prepared pipe end. The fluid applicator remains sealed during the multi-step application process, as will be apparent from the description herein.

In some embodiments a conically shaped locator end is provided to engage and align a partially inserted prepared pipe end. A seal on the outer sleeve of the fluid applicator may co-operate with the conically shaped locator end so that no fluid enters the internal surface of the pipe to which the fluid is being applied.

In some embodiments, the front seal assists alignment of the pipe onto the fluid applicator.

In some embodiments, the fluid applicator is biased in a neutral position.

The fluid applicator may be made of material that does not react with the fluid being applied.

In some embodiments, fluid is transferred from the fluid reservoir to the fluid carrier under controlled flow from the fluid reservoir to the fluid carrier. The fluid may be forced from the reservoir under pressure or suction.

In some embodiments, the fluid applicator might provide a click that sounds during the operation to alert the user that the fluid application operation has been completed.

In some embodiments, the fluid carrier may have a sealing cap to prevent accidental operation during storage or transport.

Other variations and modifications will be apparent to the skilled person and the invention may take a form different from that specifically described above. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may also be provided separately or in any suitable sub-combination.

It should be noted that the term “comprising” does not exclude other elements, the term “a” or “an” does not exclude a plurality, a single feature may fulfil the functions of several features recited in the claims and reference signs in the claims shall not be construed as limiting the scope of the claims. It should also be noted that the Figures are not necessarily to scale; emphasis instead generally being placed upon illustrating the principles of the present disclosure.

1. A fluid applicator, comprising
a fluid reservoir having a dispensing aperture,
a pipe locator for locating a pipe end at a coating position in use of
the fluid applicator,
a cylindrical sleeve around the fluid reservoir, and
a fluid carrier carried by the cylindrical sleeve,
wherein the cylindrical sleeve is moveable between a first position, in which the dispensing aperture is in fluid communication with the fluid carrier and a second position in which the fluid carrier is adjacent a pipe end located at the coating position.

2. The fluid applicator as claimed in claim 1, further comprising a fluid distributor disposed within the cylindrical sleeve-, the fluid distributor being arranged to provide a fluid distribution path between the dispensing aperture of the fluid reservoir and the fluid carrier-.

3. The fluid applicator as claimed in claim 2, wherein the fluid distributor has an inner bore and an external surface,
the fluid reservoir and fluid distributor being arranged such that the dispensing aperture of the fluid reservoir is located within the inner bore of the fluid distributor,
wherein the fluid distribution path comprises a plurality of dispensing channels extending radially outwardly from the inner bore to the external surface of the fluid distributor.

4. The fluid applicator as claimed in any claim 2, further comprising a pipe disposed between the fluid reservoir and the dispensing aperture, the pipe being disposed within, and able to move relative to, the inner bore of the distributor in a sealed manner.

5. The fluid applicator as claimed in any claim 2, further comprising a spring, wherein the fluid distributor and the fluid reservoir are arranged longitudinally within the cylindrical sleeve separated by the spring.

6. The fluid applicator as claimed in claim 2, wherein the pipe locator is fixedly attached to the fluid distributor within the cylindrical sleeve.

7. The fluid applicator as claimed in claim 2, further comprising an O-ring seal disposed between the fluid distributor and the cylindrical sleeve.

8. The fluid applicator as claimed in claim 2, further comprising pressurizing means for causing fluid in the fluid reservoir to be dispensed through the fluid aperture in response to the relative motion of the fluid reservoir and the distributor caused by the movement of the sleeve.

9. The fluid applicator as claimed in claim 1, where the fluid reservoir includes a plate, moveable within the fluid reservoir, and a biasing mechanism, responsive to the fluid pressure within the fluid reservoir, for moving the plate within the fluid reservoir to maintain fluid pressure in the fluid reservoir.

10. The fluid applicator as claimed in claim 1, further comprising a one way valve, arranged to cooperate with the dispensing aperture to allow fluid to be dispensed from the dispensing aperture during movement of the sleeve from the first position of the sleeve to the second position of the sleeve, and to prevent fluid passing through the dispensing aperture during movement of the sleeve from the second position of the sleeve to the first position of the sleeve.

11. The fluid applicator as claimed in claim 1, comprising
an end cap at the trailing end of the cylindrical sleeve-, and
an end cap spring disposed between the end cap and the fluid reservoir.

12. (canceled)

13. The fluid applicator as claimed in claim 1, further comprising an annular ring having a locating portion disposed on a leading end of the cylindrical sleeve adjacent the coating position, the locating portion being shaped to co-operate with the pipe locator to align a pipe with the fluid applicator during use of the fluid applicator.

14. (canceled)

15. The fluid applicator as claimed in claim 1, wherein the cylindrical sleeve supports the fluid carrier- on an inner wall of the cylindrical sleeve.

16. The fluid applicator as claimed in claim 1, wherein the fluid carrier comprises
an annular support mounted within the cylindrical sleeve, and
a plurality of fluid carrier pads supported by the annular support.

17. The fluid applicator as claimed in claim 1 wherein pressure means is provided to pressurize fluid in the fluid reservoir to pass fluid through said dispensing aperture onto the fluid carrier-.

18. The fluid applicator as claimed in claim 17 wherein the pressure means may be a piston and cylinder device.

19. The fluid applicator as claimed in claim 13 wherein the piston may be driven by rotation of a screw thread shaft passing through a screw threaded aperture in the piston.

20. The fluid applicator as claimed in claim 17 wherein one end of the fluid reservoir may include a projection to engage the inside of a pipe to be coated with fluid.

21. The fluid applicator as claimed in claim 20 wherein the projection may be conical.

22. The fluid applicator as claimed in claim 17, wherein the action of sliding the sleeve from the first position to the second position and/or vice versa operates said pressure means to dispense fluid through said apertures onto the fluid carrier, whereby the fluid carrier is always primed with fluid before the sleeve is moved from the first position to the second position.

23. (canceled)
